(19) United States
(12) Patent Application Publication
(10) Pub. No.: US 2017/0149883 A1
(43) Pub. Date: May 25, 2017

(54) DATA REPLICATION IN A DATA STORAGE SYSTEM HAVING A DISJOINTED NETWORK

(71) Applicant: DataDirect Networks, Inc., Chatsworth, CA (US)

(72) Inventors: Rajkumar Joshi, Simi Valley, CA (US); David Fellinger, Westlake Village, CA (US); Dan Olster, Woodland Hills, CA (US)

(21) Appl. No.: 14/948,147

(22) Filed: Nov. 20, 2015

(51) Int. Cl. H04L 29/08

(52) U.S. Cl. CPC H04L 67/1095; H04L 67/1097; H04L 67/16

(57) ABSTRACT

Systems and methods for data replication in a data storage system having a disjointed network are described herein. The data storage system includes a plurality of clusters each having at least one stationary zone. The data storage system further includes at least one movable zone. Each zone has a plurality of storage nodes, and each storage node has a plurality of storage devices. The system provides for replication according to policies associated with data objects such that data items are stored among a plurality of zones. Movable zone that are disconnected from and reconnected to the other zones and clusters in the storage system are supported.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

Field

This disclosure relates to data stored in a data storage system and a method for storing data in a data storage system that allows for replication when a certain node or nodes are offline or unavailable to the core system.

Description of the Related Art

A file system is used to store and organize computer data stored as electronic files. File systems allow files to be found, read, deleted, and otherwise accessed. File systems store files on one or more storage devices. File systems store files on storage media such as hard disk drives, magnetic tape and solid-state storage devices.

Various applications may store large numbers of documents, images, audio, videos and other data as objects using a distributed data storage system in which data is replicated and stored in multiple locations for resiliency.

### DESCRIPTION OF THE DRAWINGS

FIG. 1 is a block diagram of a data storage system.

FIG. 2 is a block diagram of a storage zone included in a data storage system.

FIG. 3 is a block diagram of an object identifier (OID) for objects stored and managed by the data storage system.

FIG. 4 is a flow chart of the actions taken to add a zone to a data storage system.

FIG. 5 is a flow chart of the actions taken when a movable storage zone connects to a stationary storage zone or cluster in a data storage system.

### DETAILED DESCRIPTION

The systems and methods described herein provide for a replicated data storage system that accommodates nodes that are unavailable or inaccessible for certain periods of time. In practice this system is useful when vessels, vehicles or aircraft are out of range, are not in port or are otherwise unable to be continuously connected to a network for operational, research or military considerations. For example, a ship at sea, a submarine exploring the floor of the ocean, aircraft flying at high altitude, and movable command centers involved with research, surveillance and/or command and control activities may all contain storage zones that are regularly inaccessible to a core network and connect and reconnect to the core network at intervals.

Environment

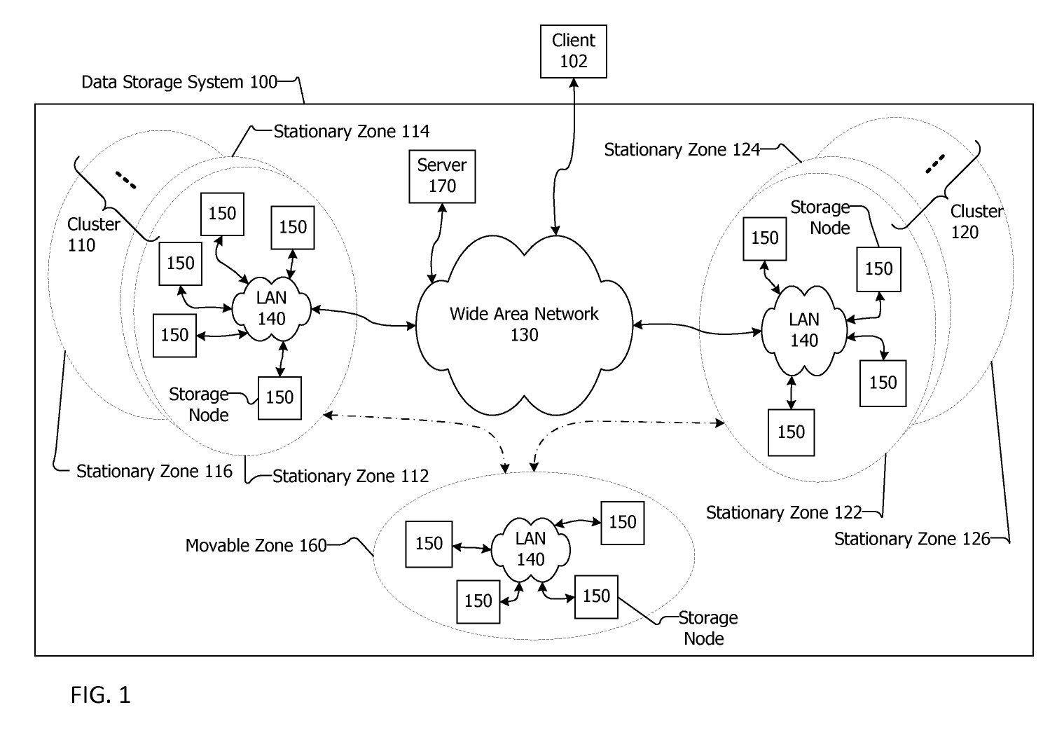

FIG. 1 is a block diagram of a data storage system 100. The data storage system 100 includes at least two storage clusters, each storage cluster having at least one and more typically a plurality of storage zones. The data storage system 100 typically includes multiple storage zones that are independent of one another. The storage zones may be autonomous. The storage zones may be in a peer-to-peer configuration. The storage zones may be arranged into clusters 110 and 120. The storage clusters and/or the storage zones may be geographically dispersed. Storage zones may for a cluster such as multiple zones in different buildings in a campus or base forming a single cluster at that campus or base. In additional to traditional stationary storage zones (that is, stationary zones), there are also movable storage zones (that is, movable zones). Stationary zones are not movable and are in a fixed location, such as for example, a computer room, lab, tech center or the like. Movable zones are storage zones that are not continuously connected to the data storage system or a particular storage zone and regularly connect, disconnect and reconnect to the data storage system via the storage clusters.

In the example shown in FIG. 1, the data storage system 100 includes two storage clusters 110 and 120 each having a plurality of stationary storage zones 112, 114, 116, 122, 124 and 126. In addition, movable zone 160 may sometimes be connected to storage cluster 110, other times be connected to storage cluster 120, and other times not be connected to any storage cluster in the data storage system 100. In other configurations, more than three storage zones are included each storage cluster, and a storage cluster may have only one storage zone. More than two stationary zones may be included in the data storage system. In addition, more than one movable zone may be included in the data storage system. The stationary storage zones and movable storage zones may replicate data included in other storage zones within or outside the cluster in which the storage zone is located. The data storage system 100 may be a distributed replicated data storage system.

The storage clusters 110 and 120 may be separated geographically, may be in separate states, may be in separate countries, may be in separate cities, may be in the same campus or base, may be in different campuses or bases, may be in separate buildings on a shared site, may be on separate floors of the same building, and arranged in other configurations. The stationary zones may be separated in the same location, may be in separate racks, may be in separate buildings on a shared site, may be on separate floors of the same building, and arranged in other configurations. Movable zone 160 may regularly or occasionally be near other storage zones that are part of storage clusters and may regularly or occasionally connect, disconnect and reconnect to the data storage system 100 via one of the storage clusters 110 and 120. The discontinuous nature of the connection of movable zone 160 is shown by the discontinuous lines between the movable zone 160 and stationary zone 112 of cluster 110 and stationary zone 122 of cluster 120. The regular or occasional disconnection and reconnection of a movable zone makes the network of the data storage system a disjointed network such that the data storage system is a disjointed data storage system.

The storage clusters, stationary zones and movable zones communicate with each other and share objects over wide area network 130. The wide area network 130 may be or include the Internet. The wide area network 130 may be wired, wireless, or a combination of these. The wide area network 130 may be public or private, may be a segregated network, and may be a combination of these. The wide area network 130 may include enhanced security features and may not be connected to the Internet. The wide area network 130 includes networking devices such as routers, firewalls, hubs, gateways, switches and the like.

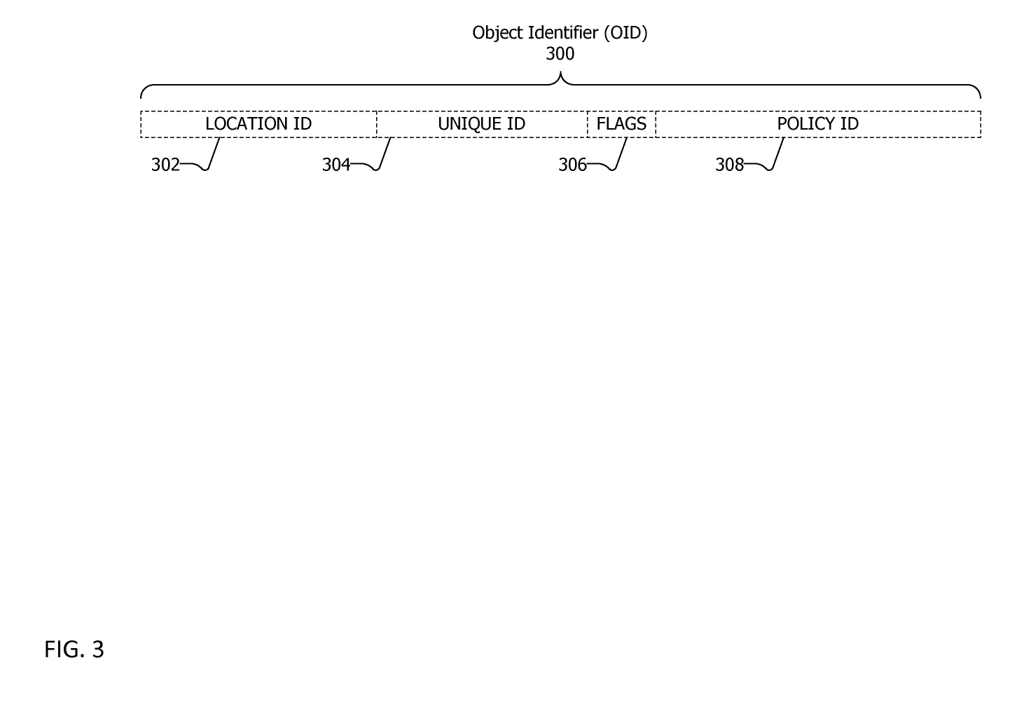

The data storage system 100 may include a server 170 coupled with wide area network 130. The server 170 may augment or enhance the capabilities and functionality of the data storage system by promulgating policies, receiving and distributing search requests, compiling and/or reporting search results, and tuning and maintaining the data storage system. The server 170 may include and maintain an object database on a local storage device included in or coupled with the server 170. The object database may be indexed according to the object identifier or OIDs of the objects stored in the data storage system. In various embodiments, the object database may only store a small amount of information for each object or a larger amount of information. Pertinent to this patent is that the object database store policy information for objects. In one embodiment, the object database is an SQLITE® database. In other embodiments, the object database may be a MONGODB®, Voldemort, or other key-value store. The objects and the object database may be referenced by object identifiers or OIDs like those shown and described below regarding FIG. 3.

The term data as used herein includes a bit, byte, word, block, stripe or other unit of information. In one embodiment, data is stored within and by the distributed replicated data storage system as objects. A data item may be store as one object or multiple objects. That is, an object may be a data item or a portion of a data item. As used herein, the term data item is inclusive of entire computer readable files or portions of a computer readable file. The computer readable file may include or represent text, numbers, data, images, photographs, graphics, audio, video, raw data, scientific data, computer programs, computer source code, computer object code, executable computer code, and/or a combination of these and similar information.

Many data intensive applications store a large quantity of data, these applications include scientific applications, newspaper and magazine websites (for example, nytimes.com), scientific lab data capturing and analysis programs, video and film creation software, and consumer web based applications such as social networking websites (for example, FACEBOOK®), photo sharing websites (for example, FLICKR), geo-location based and other information services such as NOW from Google Inc. and SIRI® from Apple Inc., video sharing websites (for example, YOUTUBE®) and music distribution websites (for example, ITUNES®).

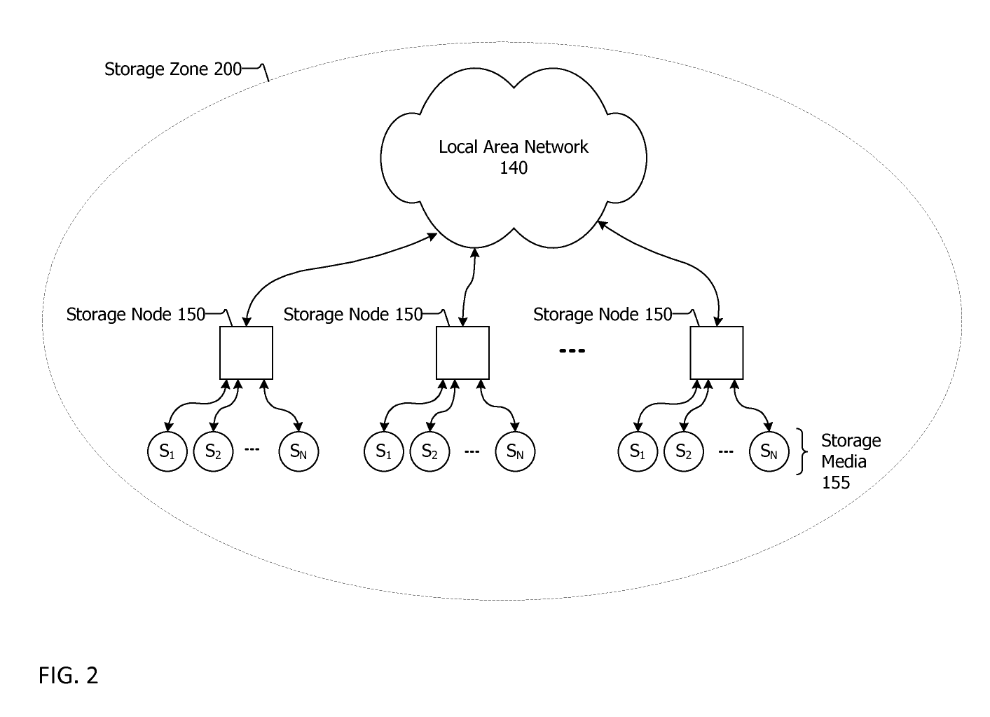

FIG. 2 is a block diagram of a storage zone 200 included in a data storage system. The stationary zones 112, 114, 116, 122, 124 and 126 and movable zone 160 shown in FIG. 1 and described above are examples of storage zone 200. The storage nodes 150 within a storage zone 200 may be connected via a local area network 140 by wire lines, optical fiber cables, wireless communication connections, and others, and may be a combination of these. The local area network 140 may include enhanced security features. The local area network 140 may include one or more networking devices such as routers, hubs, firewalls, gateways, switches and the like.

The storage zones, namely stationary zones 112, 114, 116, 122, 124 and 126 and movable zone 160, include a computing device and/or a controller on which software may execute. The computing device and/or controller may include one or more of logic arrays, memories, analog circuits, digital circuits, software, firmware, and processors such as microprocessors, field programmable gate arrays (FPGAs), application specific integrated circuits (ASICs), programmable logic device (PLDs) and programmable logic array (PLAs). The hardware and firmware components of the computing device and/or controller may include various specialized units, circuits, software and interfaces for providing the functionality and features described herein. The processes, functionality and features described herein may be embodied in whole or in part in software which operates on a controller and/or one or more computing devices in a storage zone, and may be in the form of one or more of firmware, an application program, object code, machine code, an executable file, an applet, a COM object, a dynamic linked library (DLL), a dynamically loaded library (.so), a script, one or more subroutines, or an operating system component or service, and other forms of software. The hardware and software and their functions may be distributed such that some actions are performed by a controller or computing device, and others by other controllers or computing devices within a storage zone.

A computing device as used herein refers to any device with a processor, memory and a storage device that may execute instructions such as software including, but not limited to, server computers, personal computers, portable computers, laptop computers, smart phones and tablet computers. Server 170 is, depending on the implementation, a specialized or general purpose computing device. The computing devices may run an operating system, including, for example, versions of the Linux, Unix, MICROSOFT® Windows, Solaris, Symbian, Android, Chrome, and APPLE® Mac OS X operating systems. Computing devices may include a network interface in the form of a card, chip or chip set that allows for communication over a wired and/or wireless network. The network interface may allow for communications according to various protocols and standards, including, for example, versions of Ethernet, INFINIBAND® network, Fibre Channel, and others. A computing device with a network interface is considered network capable.

Referring again to FIG. 2, the storage zone 200 includes a plurality of storage nodes 150 which include a plurality of storage media 155. Each of the storage nodes 150 may include one or more server computers. Each of the storage nodes 150 may be an independent network attached storage (NAS) device or system. The terms “storage media” and “storage device” are used herein to refer nonvolatile media and storage devices. Nonvolatile media and storage devices are media and devices that allow for retrieval of stored information after being powered down and then powered up. That is, nonvolatile media and storage devices do not lose stored information when powered down but maintain stored information when powered down. Storage media and devices refer to any configuration of hard disk drives (HDDs), solid-states drives (SSDs), silicon storage devices, flash memory devices, magnetic tape, optical discs, nonvolatile RAM, carbon nanotube memory, ReRam memristors, and other similar nonvolatile storage media and devices. Storage devices and media include magnetic media and devices such as hard disks, hard disk drives, tape and tape players, flash memory and flash memory devices; silicon-based media; nonvolatile RAM including memristors, resistive random-access memory (ReRam), and nano-RAM (carbon nanotubes) and other kinds of NV-RAM; and optical disks and drives such as DVD, CD, and BLU-RAY® discs and players. Storage devices and storage media allow for reading data from and/or writing data to the storage device/storage medium. Hard disk drives, solid-states drives and/or other storage media 155 may be arranged in the storage nodes 150 according to any of a variety of techniques.

The storage media included in a storage node may be of the same capacity, may have the same physical size, and may conform to the same specification, such as, for example, a hard disk drive specification. Example sizes of storage media include, but are not limited to, 2.5″ and 3.5″. Example hard disk drive capacities include, but are not limited to, 1, 2 3 and 4 terabytes. Example hard disk drive specifications include Serial Attached Small Computer System Interface (SAS), Serial Advanced Technology Attachment (SATA), and others. An example storage node may include 16 three terabyte 3.5″ hard disk drives conforming to the SATA standard. In other configurations, the storage nodes 150 may include more and fewer drives, such as, for example, 10, 12, 24 32, 40, 48, 64, etc. In other configurations, the storage media 155 in a storage node 150 may be hard disk drives, silicon storage devices, magnetic tape devices, other storage media, or a combination of these. In some embodiments, the physical size of the media in a storage node may differ, and/or the hard disk drive or other storage specification of the media in a storage node may not be uniform among all of the storage devices in a storage node 150.

The storage media 155 in a storage node 150 may be included in a single cabinet, rack, shelf or blade. When the storage media in a storage node are included in a single cabinet, rack, shelf or blade, they may be coupled with a backplane. A controller may be included in the cabinet, rack, shelf or blade with the storage devices. The backplane may be coupled with or include the controller. The controller may communicate with and allow for communications with the storage media according to a storage media specification, such as, for example, a hard disk drive specification. The controller may include a processor, volatile memory and non-volatile memory. The controller may be a single computer chip such as an FPGA, ASIC, PLD and PLA. The controller may include or be coupled with a network interface.

In one embodiment, a controller for a node or a designated node, which may be called a primary node, may handle coordination and management of the storage zone. The coordination and management handled by the controller or primary node includes the distribution and promulgation of storage and replication policies. The controller or primary node may implement the replication processes described herein. The controller or primary node may communicate with a server, such as server 170, and maintain and provide local system health information to the requesting server.

In another embodiment, multiple storage nodes 150 are included in a single cabinet or rack such that a storage zone may be included in a single cabinet. When in a single cabinet or rack, storage nodes and/or constituent storage media may be coupled with a backplane. A controller may be included in the cabinet with the storage media and/or storage nodes. The backplane may be coupled with the controller. The controller may communicate with and allow for communications with the storage media. The controller may include a processor, volatile memory and non-volatile memory. The controller may be a single computer chip such as an FPGA, ASIC, PLD and PLA.

A zone may be constructed in one or more racks, shelfs, cabinets and/or other storage units that may be movable or transportable, particularly in the case of movable zones. The movable zone may be included in a single storage unit that may be movable between stationary locations and movable vehicles, watercraft and aircraft. The rack, shelf or cabinet containing a storage zone may include a communications interface that allows for connection to other storage zones, a computing device and/or to a network. The rack, shelf or cabinet containing a storage node 150 may include a communications interface that allows for connection to other storage nodes, a computing device and/or to a network. The communications interface may allow for the transmission of and receipt of information according to one or more of a variety of wired and wireless standards, including, for example, but not limited to, universal serial bus (USB), IEEE 1394 (also known as FIREWIRE® and I.LINK®), Fibre Channel, Ethernet, WiFi (also known as IEEE 802.11). The backplane or controller in a rack or cabinet containing a storage zone may include a network interface chip, chipset, card or device that allows for communication over a wired and/or wireless network, including Ethernet. The backplane or controller in a rack or cabinet containing one or more storage nodes 150 may include a network interface chip, chipset, card or device that allows for communication over a wired and/or wireless network, including Ethernet. In various embodiments, the storage zone, the storage node, the controller and/or the backplane may provide for and support 1, 2, 4, 8, 12, 16, 32, 48, 64, etc. network connections and may have an equal number of network interfaces to achieve this.

The techniques discussed herein are described with regard to storage media and storage devices including, but not limited to, hard disk drives, magnetic tape, optical discs, and solid-state drives. The techniques may be implemented with other readable and writable optical, magnetic and silicon-based storage media as well as other storage media and devices described herein.

In the data storage system 100, files and other data are stored as objects among multiple storage media 155 in a storage node 150. Files and other data are partitioned into smaller portions referred to as objects. The objects are stored among multiple storage nodes 150 in a storage zone. In one embodiment, each object includes a storage policy identifier and a data portion. The object including its constituent data portion may be stored among storage nodes and storage zones according to the storage policy specified by the storage policy identifier included in the object. Various policies may be maintained and distributed or known to the nodes in all zones in the distributed data storage system. The policies may be stored on and distributed from a client 102 to the data storage system 100 and to all zones in the data storage system and to all nodes in the data storage system. The policies may be stored on and distributed from a server 170 to the data storage system 100 and to all zones in the data storage system and to all nodes in the data storage system. The policies may be stored on and distributed from a primary node or controller in each storage zone in the data storage system.

As used herein, policies specify replication and placement for the object among the storage nodes and storage zones of the data storage system. In other versions of the system, the policies may specify additional features and components. The replication and placement policy defines the replication, encoding and placement of data objects in the data storage system. Example replication and placement policies include, full distribution, single copy, single copy to a specific zone, copy to all zones except a specified zone, copy to half of the zones, copy to zones in certain geographic area, copy to all zones except for zones in certain geographic areas, and others. In addition, the policy may specify that the objects are to be erasure encoded in which the data is encoded and stored across multiple storage devices, storage nodes and/or storage zones in the data storage system. A character (e.g., A, B, C, etc.) or number (0, 1, 2, etc.) or combination of one or more characters and numbers (A1, AAA, A2, BC3, etc.) or other scheme may be associated with and used to identify each of the replication, encoding and placement policies. The policy may be stored as a byte or word, where a byte is 8 bits and where a word may be 16, 24, 32, 48, 64, 128, or other number of bits. The policy is included as a policy identifier in an object identifier shown in FIG. 3 as policy identifier 308 in object identifier 300.

Referring again to FIG. 1, the client 102 of the storage system 100 may be a computing device such as, for example, a personal computer, tablet, mobile phone, workstation or server, and may be group of computers or computing nodes arranges as a super computer. The wide area network 130 may connect geographically separated storage zones. Each of the storage zones includes a local area network 140.

The data storage systems described herein may provide for one or multiple kinds of storage replication and data resiliency. The data storage systems described herein may operate as a fully replicated distributed data storage system in which all data is replicated among all storage zones such that all copies of stored data are available from and accessible from all storage zones. This is referred to herein as a fully replicated storage system.

Another configuration of a data storage system provides for partial replication such that data may be replicated in one or more storage zones in addition to an initial storage zone to provide a limited amount of redundancy such that access to data is possible when a zone goes down or is impaired or unreachable, without the need for full replication. The partial replication configuration does not require that each zone have a full copy of all data objects.

Replication may be performed synchronously, that is, completed before the write operation is acknowledged; asynchronously, that is, the replicas may be written before, after or during the write of the first copy; or a combination of each. During data ingest, synchronous replication provides for a high level of data resiliency while asynchronous replication provides for resiliency at a lower level. As described herein, replication may be synchronous and/or asynchronous while all zones are connected to the data storage system. When a movable zone is disconnected from the system, the remaining stationary and connected movable zones may operate in a synchronous manner, but the overall system operates in an asynchronous manner as the movable disconnected zone is not connected to the data storage system.

To facilitate the management and replication of objects in the data storage system, an object database on the server 170 may store information about each object. The object database may be indexed according to the object identifier or OIDs of the objects. The object database may be an SQLITE® database. In other embodiments the database may be a MONGODB®, Voldemort, or other key-value store.

The objects and the object database may be referenced by object identifier or OIDs like those shown and described regarding FIG. 3. Referring now to FIG. 3, a block diagram of an object identifier 300 used in the data storage system is shown. According to the data storage system described herein, an object identifier 300 includes four components and may include three or more components. The object identifier 300 includes a location identifier 302, a unique identifier 304, flags 306 and a policy identifier 308. The object identifier 300 may optionally include flags 306 and other fields. The location identifier 302 specifies a device, address, storage node or nodes where an object resides. The specific format of the location identifier may be system dependent.

In one version of the system, the location identifier 302 is 30 bits, but may be other sizes in other implementations, such as, for example, 24 bits, 32 bits, 48 bits, 64 bits, 128 bits, 256 bits, 512 bits, etc. In one version of the system, the location identifier 302 includes both a group identifier (“group ID”) and an index. The group ID may represent a collection of objects stored under the same policy, and having the same searchable metadata fields. The group ID of the object becomes a reference for the embedded database of the object group. The group ID may be used to map the object to a particular storage node or storage device, such as a hard disk drive. The mapping may be stored in a mapping table maintained by the object storage system. The mapping information is distributed and is hierarchical. More specifically, the system stores a portion of mapping information in memory, and the storage nodes hold a portion of the mapping information in their memory. Master copies of the mapping information are kept on disk or other nonvolatile storage medium on the storage nodes. The master copies of the mapping information are dynamically updated to be consistent with any changes made while the system is active. The index may be the specific location of the object within the group. The index may refer to a specific location on disk or other storage device.

The unique identifier 304 is a unique number or alphanumeric sequence that is used to identify the object in the storage system. The unique identifier 304 may be randomly generated, may be the result of a hash function of the object itself (that is, the data or data portion), may be the result of a hash function on the metadata of the object, or may be created using another technique. In one embodiment, the unique identifier is assigned by the controller in such a manner that the storage device is used efficiently. The unique identifier 304 may be stored as 24 bits, 32 bits, 64 bits, 128 bits, 256 bits, 512 bits, 1 kilobyte, etc.

The object identifier 300 may optionally include flags 306. Flags 306 may be used to distinguish between different object types by providing additional characteristics or features of the object. The flags may be used by the data storage system to evaluate whether to retrieve or delete objects. In one embodiment, the flags associated with the object indicate if the object is to be preserved for specific periods of time, or to authenticate the client to ensure that there is sufficient permission to access the object. In one version of the system, the flags 306 portion of the OID 300 is 8 bits, but may be other sizes in other implementations, such as, for example, 16 bits, 32 bits, 48 bits, 64 bits, 128 bits, 256 bits, 512 bits, etc.

The policy identifier 308 is described above in para. [0032].

The total size of the object identifier may be, for example, 128 bits, 256 bits, 512 bits, 1 kilobyte, 4 kilobytes, etc. In one embodiment, the total size of the object identifier includes the sum of the sizes of the location identifier, unique identifier, flags, policy identifier, and version identifier. In other embodiments, the object identifier includes additional data that is used to obfuscate the true contents of the object identifier. In other embodiments, other kinds and formats of OIDs may be used.

In some embodiments, when the data objects are large, the data object may be partitioned into sub-objects. The flags 308 may be useful in the handling of large data objects and their constituent sub-objects. Similarly, the group ID may be included as part of the location ID 304, and may be used in mapping and reassembling the constituent parts of large data objects.

Processes

The methods described herein accommodate movable zones that are disconnected from the network that connects the stationary zones. In this way, the methods describe how a disjoint storage systems manages movable zones. In practice, reconnaissance aircraft (for example airplanes, blimps, and unmanned aerial vehicles), ocean exploratory vessels (for example, ships and submarines), spacecraft (for example, satellites, space ships), mobile command centers, and the like may be disconnected from a primary network and the data storage system but reconnect regularly or occasionally. When the movable zones reconnect, the data captured and stored on the nodes in the movable zone are stored on and distributed among the stationary zones according to the particular policies for the objects stored on the movable zone. In one configuration, the objects originating from movable zones may all be members of the same object group. In other configurations the objects stored on a movable zone may be members of one or multiple object groups, and it is the groups that specify the storage and distribution requirements of the objects. The distribution of the objects from a movable zone may be determined by the object group and/or policy identifier for the particular objects.

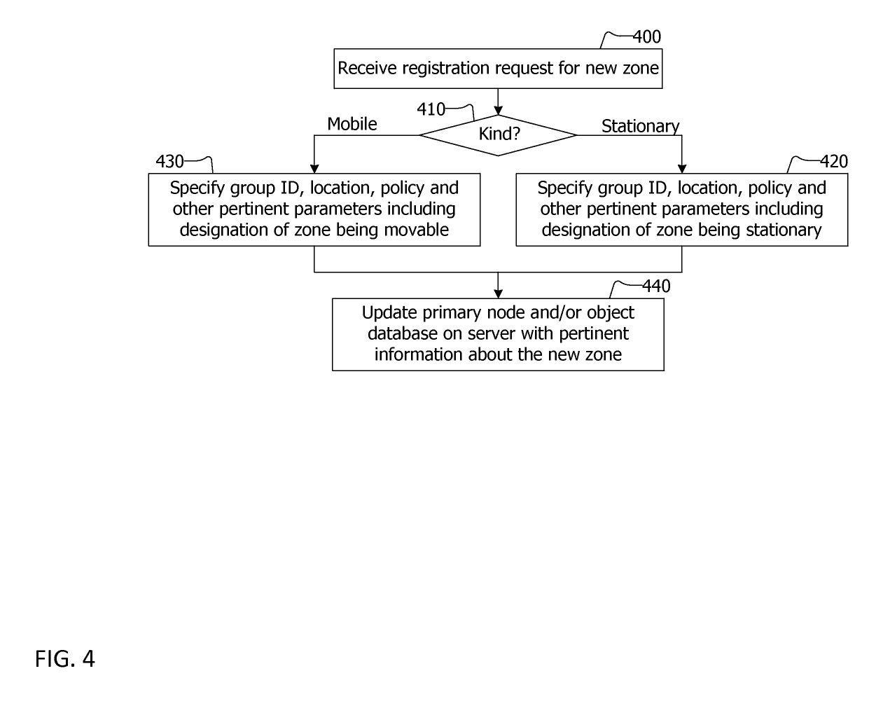

Referring now to FIG. 4, a flow chart of the actions taken to add a zone to a data storage system is shown. A registration request for new zone is received, as shown in block 400. In the registration request, the kind of zone is specified as stationary or movable, as shown in block 410. This is achieved by a numerical, alphanumerical or plain English designation. When the zone is stationary, the group ID, location, policy and other pertinent parameters including designation of the zone being stationary is specified, as shown in block 420. When the zone is stationary, the group ID, location, policy and other pertinent parameters including designation of the zone being movable is specified, as shown in block 430. Some of this information is taken from the registration request and other information is computed. The primary node and/or object database on the server is updated with pertinent information about the new zone, including for example, the number of nodes in the zone, the sizes of the nodes, etc. The designation of a zone as movable or stationary allows the data storage to recognize when it is permissible for a zone to be disconnected or out of communication with the data storage system. For example, should a stationary storage zone lose communication with or become disconnected from the data storage system remedial (curative) and notification actions may be taken, and storage polices may be adjusted to accommodate for the unreachable stationary storage zone. However, when a movable storage zone is included in a data storage system, it is expected that the movable storage zone disconnect and render the data storage system disjoint. When a movable storage zone disconnects from the data storage system, no special actions need be taken.

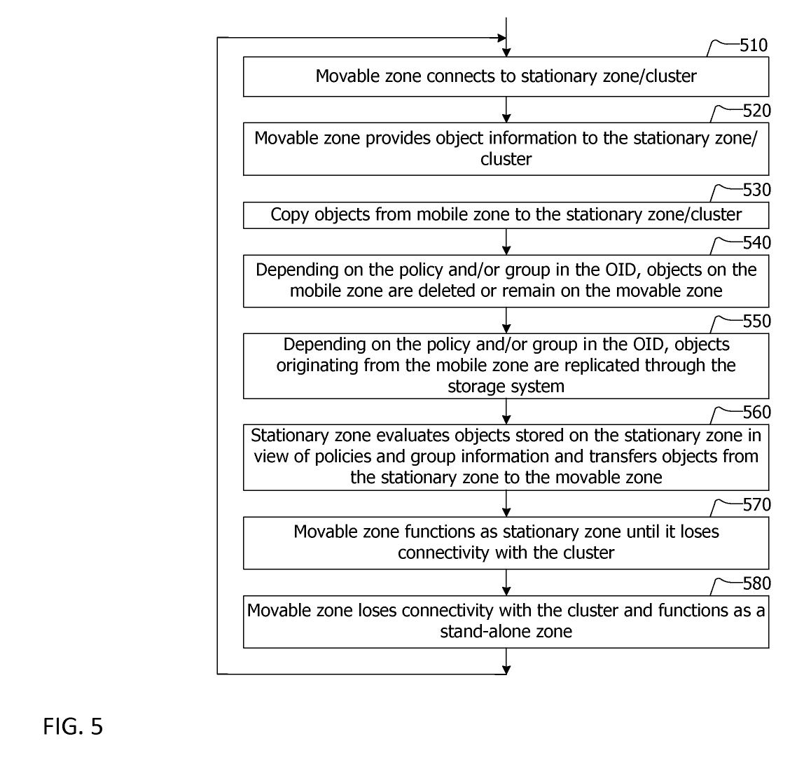

Referring now to FIG. 5, a flow chart of the actions taken when a movable storage zone connects with a stationary zone or cluster in a data storage system. A movable zone connects to stationary zone/cluster, as shown in block 510. The movable zone provides object information to the stationary zone/cluster, as shown in block 520. The objects from the movable zone that are not already in the stationary zone or cluster are copied from the movable zone to the stationary zone and the cluster, as shown in block 530. This may be achieved by the stationary zone/cluster comparing the object identifiers in the movable zone with those in the stationary zone. At the node level, this may be achieved efficiently in groups by referring to the group identifiers of the objects rather than on an object identifier by object identifier basis. This (and the other actions described regarding FIG. 5) may be performed by a primary node in the stationary zone, a controller in the stationary zone or a server coupled with the stationary zone or cluster. A decision is made to copy those objects from the movable zone taking into consideration whether the object is not stored in the stationary zone and/or cluster and/or taking into consideration whether there are newer, more recent and/or different versions of the object having the same object identifier in the stationary zone and/or in the cluster. The evaluation to determine whether the object on the movable storage zone is different from the object on stationary zone may be based consideration of one or more items of meta data about the object including the size of the object, the date of the object and the last writer of the object. After copying the objects from the movable zone is evaluated and after any copying of the objects from the movable zone to the stationary zone is complete, depending on the policy and/or group specified in the OID of objects in the movable storage zone, objects are deleted or remain on the movable storage zone, as shown in block 540.

Next, depending on the policy and/or group specified in the OID of objects copied from the movable zone to the stationary zone, objects are replicated through the storage system, as shown in block 550. This includes copying the object to other zones in the cluster to which the movable zone is currently connected as well as copying the object to other zones in other clusters in the data storage system based on the policy and/or group specified in the OID of the objects originating from the movable zone. This allows for replication of objects in the data storage system according to the policies and group information for objects stored on the movable zone.

Further, the stationary zone evaluates objects stored on the stationary zone and in the cluster in view of policies and group information and copies or transfers objects from the stationary zone to the movable zone based on the policies and group information of objects stored on the stationary zone, as shown in block 560. In this situation, in practice, objects that may have been created and stored in the stationary zone/cluster when the movable zone was disconnected are identified and copied or transferred to the movable zone. This allows for replication of objects in the data storage system according to the policies and group information for objects stored on the stationary zone throughout the data storage system.

In various configurations, the actions in blocks 530, 540, 550 and 560 may be performed concurrently, sequentially, overlapping, and/or or in any order.

The movable zone while connected with the stationary zone/cluster functions as a stationary zone until it loses connectivity with the cluster, as shown in block 570. When the movable zone loses connectivity with the cluster, it functions as a stand-alone zone, as shown in block 580. When functioning as a stand-alone zone, the movable zone cannot fully achieve the distribution requirements of the groups or policies for the objects it stores. The movable zone delays action on fulfilling the zone and/or group requirements until the movable zone regains connectivity with other zones or clusters in the data storage system. The flow of actions continues with the movable zone connecting to a stationary zone or cluster, as shown in block 510.

The methods described regarding FIG. 5 may be applied to groups of objects in an object group. This increases the efficiency of object management. To achieve this, the actions are taken upon groups of objects in an object group rather than single objects. In this way, the system manages and stores all objects in the object group having a shared specified storage policy in a uniform way to reduce the amount of processing needed to handle the object.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., “primary”, “secondary”, “tertiary”, etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

1. A data storage system comprising:
a plurality of storage zones, each storage zone comprising a plurality of nodes wherein each node comprises a plurality of storage devices and a controller, the controller including a processor and memory, wherein at least one of the storage zones is a movable storage zone and at least two of the storage zones are stationary storage zones;
a plurality of clusters, each cluster including at least one of the stationary storage zones;
a first node of a plurality of nodes included in a first stationary storage zone of the plurality of zones, the first node having instructions which when executed cause a first processor included in a first controller in the first node to perform actions including:
identifying a connection of a first movable storage zone,
receiving stored object information from the first movable storage zone,
copying objects from the first movable storage zone when the objects are not yet stored on the first stationary storage zone or when the object on the movable storage zone is different from the object on the first stationary storage zone,
deleting the copied object from the first movable storage zone based on the policy and group information of the copied object,
replicating the copied object throughout the first storage cluster based on the policy and group information of the copied object,
evaluating objects stored on the first stationary storage zone in view of policies and group information and copying objects from the first stationary storage zone to the first movable storage zone based on the evaluating.

2. The system of claim 1 wherein the storage devices are one or more selected from the group including hard disk drives, magnetic tape and silicon storage devices.

3. The system of claim 1 wherein the storage devices are non-volatile random access memory (NV-RAM).

4. The system of claim 1 wherein when the object on the movable storage zone is different from the object on the first stationary storage zone is evaluated based on at least one of size of the object, date of the object and last writer of the object.

5. The system of claim 1 wherein the first node has further instructions which when executed cause the first node to perform further actions including:
recognizing the first movable zone disconnecting from the data storage system;
delaying action on fulfilling replication requirements applicable to the first movable zone until recognizing the first movable zone regaining connectivity with the data storage system.

6. The system of claim 5 wherein the first movable zone regaining connectivity with the data storage system is through a second stationary storage zone.

7. A method for storing data in a data storage system performed by a first node of a plurality of nodes included in a first stationary storage zone of a plurality of zones in the data storage system, the first node having instructions which when executed cause a first processor included in a first controller in the first node to perform actions including:
identifying a connection of a first movable storage zone;
receiving stored object information from the first movable storage zone;
copying objects from the first movable storage zone when the objects are not yet stored on the first stationary storage zone or when the object on the movable storage zone is different from the object on the first stationary storage zone;
deleting the copied object from the first movable storage zone based on the policy and group information of the copied object;
replicating the copied object throughout the first storage cluster based on the policy and group information of the copied object;
evaluating objects stored on the first stationary storage zone in view of policies and group information and copied objects from the first stationary storage zone to the first movable storage zone based on the evaluating.

8. The method of claim 7 wherein the storage devices are one or more selected from the group including hard disk drives, magnetic tape and silicon storage devices.

9. The method of claim 7 wherein the storage devices are non-volatile random access memory (NV-RAM).

10. The method of claim 7 wherein when the object on the movable storage zone is different from the object on the first stationary storage zone is evaluated based on at least one of size of the object, date of the object and last writer of the object.

11. The method of claim 7 further comprising:
recognizing the first movable zone disconnecting from the data storage system;
delaying action on fulfilling replication requirements applicable to the first movable zone until recognizing the first movable zone regaining connectivity with the data storage system.

12. The method of claim 10 wherein the first movable zone regaining connectivity with the data storage system is through a second stationary storage zone.
